(19) United States
(12) Patent Application Publication
(10) Pub. No.: US 2008/0221864 A1
(43) Pub. Date: Sep. 11, 2008

(54) PROCESS FOR PROCEDURAL GENERATION OF TRANSLATIONS AND SYNONYMS FROM CORE DICTIONARIES

(76) Inventor: Daniel Blumenthal, Stoughton, MA (US)

Correspondence Address: JOHN ALEXANDER GALBREATH, 2516 CHESTNUT WOODS CT, REISTERSTOWN, MD, 21136, US

(21) Appl. No.: 12/044,709

(22) Filed: Mar. 7, 2008

Related U.S. Application Data
(60) Provisional application No. 60/893,652, filed on Mar. 8, 2007.

(51) Int. Cl. G06F 17/28

(52) U.S. Cl. 704/4

(57) ABSTRACT

A process that generates translations and synonyms in a database with multiple dictionaries is disclosed. When translations are required among a plurality of languages, two or more “core” languages are chosen, for which there will be dictionaries with all other languages. A given word or other semantic unit is first translated into a first core language, and the set of possible translations is then translated into the target language, generating a target output set. These steps are repeated using the second core language. Acceptable translations of the word lie in the intersection between the two target output sets. The process reduces the total number of dictionaries needed to completely translate among a given number of languages, and also increases the accuracy of the “indirect” or “intermediate” method of translation between two non-core languages. The process can also be used to generate a list of acceptable synonyms in the same language.

### CROSS-REFERENCES TO RELATED APPLICATIONS

This application claims priority from, and the benefit of, applicant's provisional U.S. Patent Application No. 60/893,652, filed Mar. 8, 2007 and titled “Process for procedural generation of translations and synonyms from core dictionaries”.

### BACKGROUND

### Field of the Invention

The disclosed systems and methods relate generally to the process of creating translations and synonyms in a multiple dictionary environment.

### SUMMARY OF THE INVENTION

Described herein is a process that generates translations and synonyms in a database with multiple dictionaries.

Given a set of bilingual dictionaries, in which a dictionary is defined as a reversible collection of source/target semantic units in two languages (e.g., the English word “cat” equals the Spanish word “gato” and the Spanish word “gato” equals the English word “cat”), there is often a need to translate a semantic unit between two languages for which there is no existing dictionary. For example, English/Spanish dictionaries are common enough, but Swahili/Russian dictionaries are not easy to find. It should be understood that a semantic unit as defined herein could be a word, phrase, sentence, fragment, or other construction.

As shown in FIG. 1, one solution to this problem is to find a dictionary which contains source/target pairs for one of the languages in question, and another dictionary which has source/target pairs for the other language in question, both of which dictionaries share a common third language. For example, to translate a word from French into Spanish, in lieu of a French/Spanish dictionary, one can look up the French word in a French/English dictionary and find the English equivalent. One can then look up this English equivalent in an English/Spanish dictionary to find the Spanish equivalent, and this Spanish equivalent should theoretically be the Spanish translation of the original French word.

This indirect method works well in situations where, referring to the example above, there is only one English equivalent of the French word, and in turn only one Spanish equivalent of the English equivalent. However, a single semantic unit often has multiple unrelated definitions, and this can cause the indirect method of translation to be highly inaccurate. For instance, the French word “bon” can be translated into English as “good”, “fine”, or “well”. When these multiple English translations are then translated into a third language, the indirect method can result in a variety of undesired translations. More specifically, when translating the French word “bon” into Spanish using English as the intermediate language, in the first step possible English translations might be “good”, “fine”, and “well”. In the second step, the English word “good” might be translated into the Spanish word for a dry good, the English word “fine” might be translated into the Spanish word for a monetary fine, and the English word “well” might be translated into the Spanish word for a water well. The net effect is that the French word “bon” might be translated into the Spanish word for a dry good, a monetary fine, or a water well—when what was intended was the Spanish word for “bon” in the sense of favorable or pleasing.

As shown in FIG. 2, when creating a set of dictionaries to handle a larger number of languages, the problem becomes more acute. The number of dictionaries necessary to completely cover all possible combinations of languages is equal to N*(N−1)/2, where N is the number of languages involved. So, although in the example above (N=3), you would only need three dictionaries (French/English, French/Spanish, English/Spanish), with four languages you would need six dictionaries, with five languages you would need ten, and with 100 languages you would need 4950.

As also shown in FIG. 2, this problem can be surmounted by choosing two or more “core” languages, for which there will be dictionaries with all other languages. In the case of N languages, two of which being core, this will require (2*N)−3 dictionaries, a significant savings when dealing with large numbers of dictionaries. For example, with 100 languages two of which are core, you would need 197 dictionaries to completely cover all translations, instead of the 4950 discussed above. Core languages should be chosen to be completely linguistically unrelated, so that they don't have similar homonyms (e.g., French and Spanish would be a bad pair of core languages, whereas English and Chinese would be a good pair).

When translating between a core language and another language, it can be understood that a direct dictionary exists, and no further action is required. However, when translating between two non-core languages, in the process of the invention the steps described earlier—translating from the source language to an intermediate (core) language to the target language—is completed once for each core language. For example, if English and Chinese are the core languages and a translation of a Russian word into Swahili is desired, the Russian word is first translated into English, and then each of those English equivalents is translated into Swahili, producing a set of possible Swahili translations of the original Russian word. Next, the Russian word is translated into Chinese, and then each of those Chinese equivalents is translated into Swahili, producing a second set of possible Swahili translations of the original Russian word. In sum, each of these two-step translations yields a set of possible translations, and in the process of the invention the intersection of these sets is taken to be the set of correct translations—or at least, the set of translations that has the greatest probability of being correct. Said another way, if a translation made using one core language as the intermediate language is the same as a translation made using another core language as the intermediate language, then the chances of that translation being correct are better.

It is possible to improve this process by adding additional core languages, and adding semantic information to the dictionaries, such as grammatical information that can be used in matching words. Adding a third (or fourth, fifth, etc.) core language would also allow further refinements, such as the ability to specify higher- and lower-probability suggestions. A translation that appears in three sets of possible translations would have a higher score (i.e., a higher probability of being correct) than a translation that appears in two sets of results.

In sum, the use of multiple core languages, and corresponding core dictionaries, reduces the total number of dictionaries needed to completely translate among a given number of languages, and also increases the accuracy of the “indirect” or “intermediate” method of translation between two non-core languages.

Developing Lists of Synonyms

The methodology of the invention can also be used to develop weighted lists of equivalences (synonyms). To accomplish this, as shown in FIG. 5, a semantic unit in the source language is translated into at least one core language, and then translated back into the original language. All resulting semantic units (not including the original) are possible synonyms. As with translations, with synonyms multiple core languages can be used, resulting in multiple sets of semantic units. The number of result sets in which a semantic unit appears is taken as that semantic unit's “score”. Semantic units with a score of one (i.e., appearing in only one result set) would be considered either invalid or uncommon, and such semantic units would not likely be acceptable synonyms for the original semantic unit. Put another way, if a semantic unit appeared in only one result set, the chance that it is a valid synonym is less than if it appeared in two, or all, result sets.

With two core languages, the maximum possible score is two, and all such semantic units are considered equally likely synonyms. With more than two core languages, semantic units can be prioritized by the number of result sets within which they appear. For example, with three core languages, semantic units that appear in all three result sets have a higher score, and are thus more likely to be acceptable synonyms, than semantic units that appear in two result sets. Similarly, semantic units that appear in two result sets have a higher score, and are thus more likely to be acceptable synonyms, than semantic units that appear in just one result set.

Other features, objects and advantages will become apparent from the following detailed description, which refers to the following drawings in which:

### DESCRIPTION OF THE DRAWINGS

FIG. 1 illustrates the indirect method of language translation, wherein lacking a direct dictionary between the source and target languages, the source language is first translated into an intermediate or “core” language, and then translated from that intermediate language into the target language.

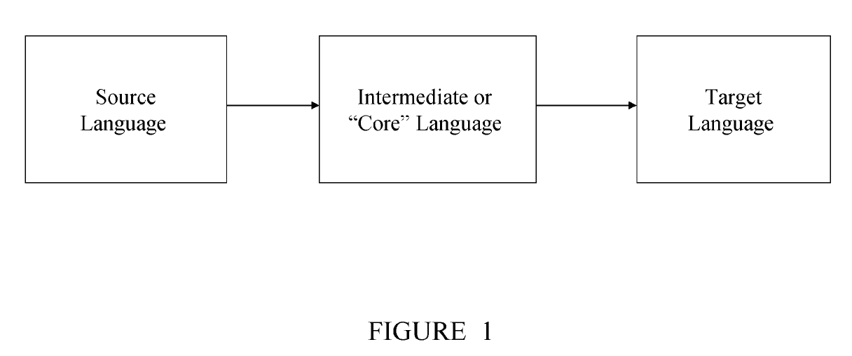

FIG. 2 illustrates the combinatoric explosion of required dictionaries (as the number of languages increases, the number of required dictionaries increases significantly), and the savings that result from using core languages/dictionaries.

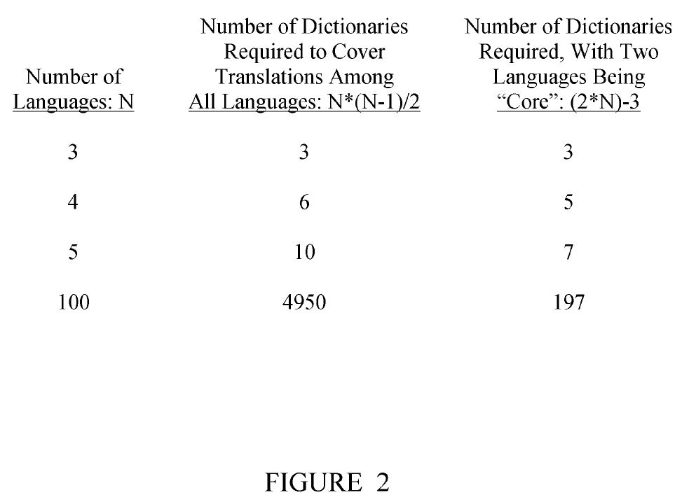

FIG. 3 illustrates the steps in the process of the invention, applied toward translating from a source to a target language using two core languages.

FIG. 4 illustrates the process of the invention, used to translate from Russian to Swahili using English and Chinese as core languages.

FIG. 5 illustrates the use of the invention's methodology to generate lists of synonyms, by translating an original semantic unit into at least one intermediate or “core” language and then translating it back into the source language.

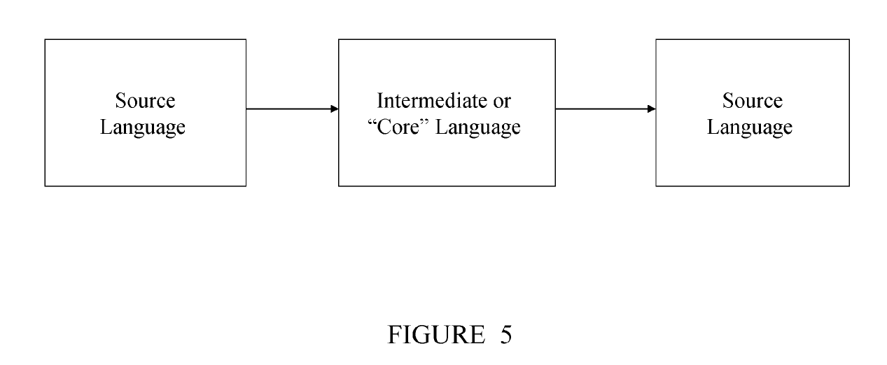

FIG. 6 illustrates the steps in the process of the invention, applied toward generating lists of potential synonyms by translating an original semantic unit from its source language to an intermediate language and then back to the source language, using two core languages.

### DETAILED DESCRIPTION OF THE INVENTION

The figures and descriptions thereof depict an embodiment of the process for illustration purposes only. It will be readily apparent to one of ordinary skill in the art that alternative embodiments of the processes and systems described herein may be employed without departing from the basic principles of the invention.

The following provides a list of the reference characters used in the drawings:
10. Specifying step
11. First intermediate translation step
12. First intermediate output set
13. First target translation step
14. First target output set
15. Second intermediate translation step
16. Second intermediate output set
17. Second target translation step
18. Second target output set
19. Translation consolidation step
20. First re-translation step
21. First result set
22. Second re-translation step
23. Second result step
24. Synonym consolidation step
25. Specifying step for synonyms

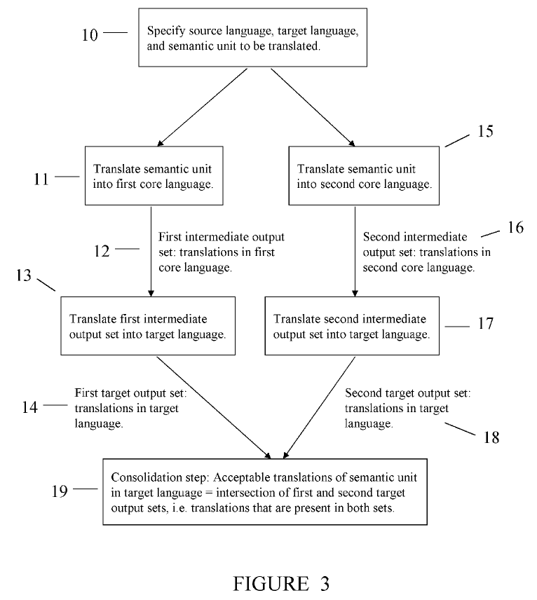

As shown in FIG. 3, in specifying step 10 a user, autonomous or semi-autonomous agent, or automated process first specifies a source language, a target language, and a semantic unit to be translated. The semantic unit is then compared against two or more core dictionaries. Each dictionary is bilingual, and provides translations between the source language and a core language. Thus, in first intermediate translation step 11, the semantic unit is translated into the first intermediate or “core” language using the first core dictionary. The result of first intermediate translation step 11 is first intermediate output set 12, which contains one or more translations of the semantic unit in the first core language. In first target translation step 13, the first core dictionary is again used, this time to translate each of the items in first intermediate output set 12 into the target language. The result of first target translation step 13 is first target output set 14, which contains one or more translations of the semantic unit in the target language.

Next, in second intermediate translation step 15, the second core dictionary is used to translate the semantic unit into the second intermediate or “core” language. The result of second intermediate translation step 15 is second intermediate output set 16, which contains one or more translations of the semantic unit in the second core language. In second target translation step 17, the second core dictionary is again used, this time to translate each of the items in second intermediate output set 16 into the target language. The result of second target translation step 17 is second target output set 18, which contains one or more translations of the semantic unit in the target language.

Next, in translation consolidation step 19 the translations in first target output set 14 are compared with the translations in second target output set 18. The intersection of first target output set 14 and second target output set 18 (that is, the translations that are present in both sets) constitute the acceptable translations—or at least, they constitute those translations which are more likely to be acceptable.

As discussed earlier, more than two core languages can be used. For example, when three core languages are used, the intermediate and target translation steps of FIG. 3 are repeated using the third core language/dictionary, eventually generating a third target output set. In this case, the acceptable translations are contained in the intersection of the three target output sets.

An example of the process using core languages of English and Chinese, and a desired translation from Russian to Swahili, follows:

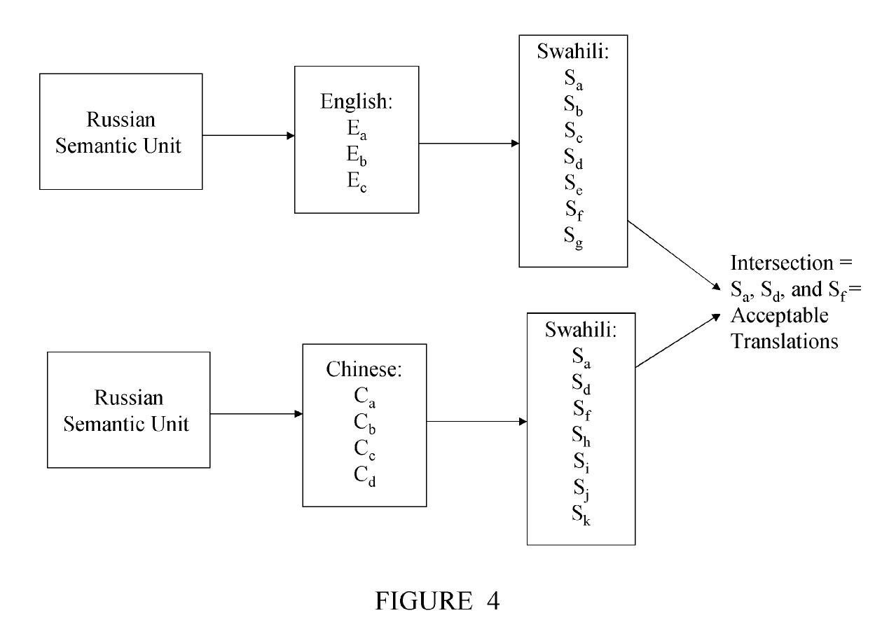

As shown in FIG. 4, the process begins by using the Russian/English dictionary to find all English translations of the Russian semantic unit. The process then uses the English/Swahili dictionary for each English translation, coming up with a set S₁ of Swahili translations comprised of Swahili translations Sₐ-S_{g}. The process is repeated using the Russian/Chinese dictionary to find all Chinese translations of the Russian semantic unit. The process then uses the Chinese/Swahili dictionary for each Chinese translation, coming up with a set S₂ of Swahili translations comprised of Swahili translations Sₐ, S_{d}, S_{f}, and Sₕ-Sₖ. The intersection of sets S₁ and S₂—that is, translations Sₐ, S_{d}, and S_{f}—are the acceptable translations. The process can of course be repeated using additional core languages, resulting in M sets (S₁ . . . S_{M}) of possible Swahili translations, where M is the number of core languages. The intersection of the sets (S₁∩S₂ . . . S_{M}) would be the acceptable translations.

Developing Lists of Synonyms

In order to search for a list of acceptable equivalences (synonyms) in the same language, the process of the invention is modified so that both the source and target languages are the same. In other words, the specified original semantic unit is first translated from the source language into one or more intermediate or “core” languages, and the resulting translations are then translated back into the source language, yielding one or more sets of possible synonyms.

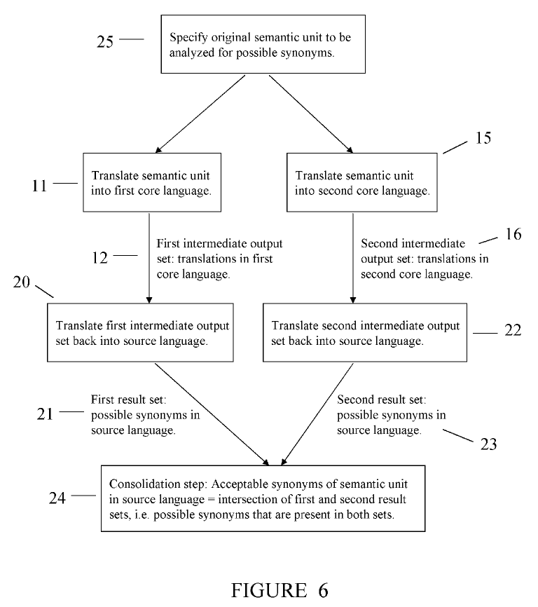

Specifically, as shown in FIG. 6, in specifying step for synonyms 25 a user, autonomous or semi-autonomous agent, or automated process specifies the semantic unit to be analyzed for possible synonyms. The semantic unit is then compared against two or more core dictionaries. Each dictionary is bilingual, and provides translations between the source language and a core language. Thus, in first intermediate translation step 11, the semantic unit is translated into the first intermediate or “core” language using the first core dictionary. The result of first intermediate translation step 11 is first intermediate output set 12, which contains one or more translations of the semantic unit in the first core language. In first re-translation step 20, the first core dictionary is again used, this time to re-translate each of the items in first intermediate output set 12 back into the source language. The result of first re-translation step 20 is first result set 21, which contains one or more possible synonyms of the original semantic unit in the source language.

Next, in second intermediate translation step 15, the second core dictionary is used to translate the semantic unit into the second intermediate or “core” language. The result of second intermediate translation step 15 is second intermediate output set 16, which contains one or more translations of the semantic unit in the second core language. In second re-translation step 22, the second core dictionary is again used, this time to translate each of the items in second intermediate output set 16 back into the source language. The result of second re-translation step 22 is second result set 23, which contains one or more possible synonyms of the original semantic unit in the target language.

Next, in synonym consolidation step 24 the possible synonyms in first result set 21 are compared with the possible synonyms in second result set 23. The intersection of first result set 21 and second result set 23 (that is, the possible synonyms that are present in both sets) constitute the acceptable synonyms—or at least, they constitute those synonyms which are more likely to be acceptable.

As discussed earlier, more than two core languages can be used. For example, when three core languages are used, the intermediate and re-translation steps of FIG. 6 are repeated using the third core language/dictionary, eventually generating a third result set. In this case, the acceptable synonyms are contained in the intersection of the three result sets.

I/we claim:

1. A method for generating translations, comprising the steps of:
a) specifying a source language, a target language, and a semantic unit to be translated from the source language into the target language,
b) translating the semantic unit from the source language into a first intermediate language, thus generating a set of translations of the semantic unit in the first intermediate language,
c) translating the set of translations from the first intermediate language into the target language, thus generating a first set of translations of the semantic unit in the target language,
d) translating the semantic unit from the source language into at least one other intermediate language, thus generating a set of translations of the semantic unit in the at least one other intermediate language,
e) translating the set of translations from the at least one other intermediate language into the target language, thus generating at least one other set of translations of the semantic unit in the target language,
f) consolidating the first set of translations of the semantic unit in the target language with the at least one other set of translations of the semantic unit in the target language in order to develop a set of acceptable translations.

2. The method of claim 1, wherein more than two intermediate languages are used, and the translations in the set of acceptable translations have varying probabilities of being correct.

3. The method of claim 1, wherein the semantic unit is a word or combination of words.

4. The method of claim 1, wherein the intermediate languages are linguistically unrelated.

5. The method of claim 1, wherein the source language and the target language are the same, and the set of acceptable translations represents a set of acceptable synonyms for the semantic unit.

6. The method of claim 5, wherein more than two intermediate languages are used, and the synonyms in the set of acceptable synonyms have varying probabilities of being correct.

7. The method of claim 1, wherein the translating steps are performed using at least two core dictionaries, each capable of translating the semantic unit from the source language into an intermediate language and then from the intermediate language into the target language.

8. A method for generating translations, comprising the steps of:
a) specifying a source language, a target language, and a semantic unit to be translated from the source language into the target language,
b) specifying at least two intermediate languages,
c) providing means for translating the semantic unit from the source language into the at least two intermediate languages and then from the intermediate languages into the target language, thus generating at least two sets of translations of the semantic unit in the target language, and
d) developing a set of acceptable translations of the semantic unit in the target language, said set of acceptable translations comprising the intersection between or among the at least two sets of translations of the semantic unit in the target language.

9. The method of claim 8, wherein more than two intermediate languages are used, and the translations in the set of acceptable translations have varying probabilities of being correct.

10. The method of claim 8, wherein the semantic unit is a word or combination of words.

11. The method of claim 8, wherein the intermediate languages are linguistically unrelated.

12. The method of claim 8, wherein the source language and the target language are the same, and the set of acceptable translations represents a set of acceptable synonyms for the semantic unit.

13. The method of claim 12, wherein more than two intermediate languages are used, and the synonyms in the set of acceptable synonyms have varying probabilities of being correct.

14. The method of claim 8, wherein the translating steps are performed using at least two core dictionaries, each capable of translating the semantic unit from the source language into an intermediate language and then from the intermediate language into the target language.

15. A system for generating translations, comprising:
a) means for specifying a source language, a target language, and a semantic unit to be translated from the source language into the target language,
b) at least two core dictionaries, each capable of translating the semantic unit from the source language into an intermediate language and then from the intermediate language into the target language, thus generating at least two sets of translations of the semantic unit in the target language, and
c) means to evaluate the at least two sets of translations of the semantic unit in the target language and indicate therefrom a set of acceptable translations, said set of acceptable translations comprising the intersection between or among the at least two sets of translations of the semantic unit in the target language.

16. The method of claim 15, wherein more than two intermediate languages are used, and the translations in the set of acceptable translations have varying probabilities of being correct.

17. The method of claim 15, wherein the semantic unit is a word or combination of words.

18. The method of claim 15, wherein the intermediate languages are linguistically unrelated.

19. The method of claim 15, wherein the source language and the target language are the same, and the set of acceptable translations represents a set of acceptable synonyms for the semantic unit.

20. The method of claim 19, wherein more than two intermediate languages are used, and the synonyms in the set of acceptable synonyms have varying probabilities of being correct.
